(19) United States
(12) Patent Application Publication
(10) Pub. No.: US 2008/0135387 A1
(43) Pub. Date: Jun. 12, 2008

(54) Man-Machine InTerface Embedded Module

(76) Inventor: Thomas Chiang, Kuei San Industrial Park (TW)

Correspondence Address: HDSL, 4331 STEVENS BATTLE LANE, FAIRFAX, VA, 22033, US

(21) Appl. No.: 11/567,792

(22) Filed: Dec. 7, 2006

(51) Int. Cl. H01H 9/00

(52) U.S. Cl. 200/309

(57) ABSTRACT

A man-machine interface embedded module with a hint function includes a main man-machine system and a socket. The main man-machine system has an operating interface. The operating interface has a plurality of function keys and a plurality of windows. The position of each window corresponds to each function key. The back of the main system has an insert slot disposed precisely corresponding to the positions of the plurality of windows, and the socket is plugged into the insert slot. The socket has a rectangular casing surface precisely corresponding to the position of the window, and a label is attached onto the casing surface. The label has a plurality of texts for describing the functions. After the socket is plugged into the insert slot, the texts on the label corresponding to each function key are shown from each window for facilitating users to identify the function of each function key.

### BACKGROUND OF THE INVENTION

1. Field of the Invention

The present invention relates to a man-machine interface, and more particular to a man-machine interface structure with a hint function.

2. Description of Prior Art

As industrialization advances, it is a trend of operating machines and equipments by man-machine interfaces to improve the working performance and save the labor cost. Users can operate a machine by using a man-machine interface to perform different functions corresponding to the options shown on a menu comprised of function keys and input groups, so as to simplify the operation procedure and improve the convenience of operating the equipments.

Function keys corresponding to different operating functions are provided in an operating interface of the conventional man-machine interface, and these function keys are restricted by the area of the operating interface and different languages. Therefore, simple codes, numbers or symbols are used for denoting the functions of the function keys, and users may need to carefully read an operating manual and fully understand the function of each function key before using the function keys for the operation of the equipments.

For convenience, most users make use of the a textual notes provided below the keys for reference to save the trouble of checking the operating manual frequency, but the textual notes may ruin the artistic external look of the operating interface. Therefore, some man-machine interface manufacturers overcome the inconvenience of identifying each function key by designing a plurality of small transparent pockets on the structure of the man-machine interface, and each pocket disposed at a bottom, a left side or a right side of each function key is provided for facilitating users to mark the notes on a piece of paper and put the note into the pocket, such that users can confirm the function of each function key.

As described in the previous section, the operating interface has a limited area, and it is necessary to minimize the size of the transparent pockets, otherwise it will cause inconvenience for user to change or swap the textual notes. Since the habits of using a different language vary, therefore the conventional man-machine interface is unable to satisfy the spatial requirements.

To overcome the aforementioned inconvenience, conventional man-machine interface structures usually include a transparent window disposed below each function key and a slot disposed on a side of the structure to facilitate users to insert a slender label that is marked with a corresponding function of each function key and inserted into the slot, and the labels are stacked in each window for describing the corresponding function keys. Since the slender labels may be bent, twisted or damaged easily when it is inserted into the slot, the labels cannot correspond to the positions of the windows or the labels may be torn after being swapped repeatedly for many times, and the slot may be jammed by the remains of the torn labels, such that the labels cannot be drawn out easily. All of the foregoing existing problems demand immediate attentions and require feasible solutions.

### SUMMARY OF THE INVENTION

In view of the foregoing shortcomings of the prior art, the inventor of the present invention based on years of experience in the related industry to conduct experiments and modifications, and finally invented a man-machine interface embedded module.

Therefore, the present invention is to provide a man-machine interface embedded module with a hint function of the function keys, and the man-machine interface embedded module comprises an insert slot disposed on a structure of a main man-machine system, a movable socket corresponding to the insert slot, and a window of a corresponding function key disposed on an operating panel, such that a textual description is attached on the front end of the socket, and the socket is plugged into the insert slot and stacked at each window for reminding users about the function of each function key. The labels can be attached repeatedly to make the operations of the man-machine interface easier.

To achieve the objective, the present invention provides a man-machine interface embedded module, and its structure comprises a main man-machine system and a socket, wherein the main man-machine system has an operating interface, and the operating interface has a plurality of function keys and a plurality of windows, and each window is disposed at a position precisely corresponding to each function key. Further, an insert slot is disposed at the back of the main system and at a position precisely corresponding to the positions of the plurality of windows, and the socket is inserted into the interior of the insert slot. The socket has a rectangular casing surface precisely corresponding to the position of the window and a label attached onto the casing surface, and the label has a plurality of texts for describing the corresponding functions. After the socket is plugged into the insert slot, the text of the label can be displayed from each window corresponding to each function key for facilitating users to identify the function of each function key.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an exploded rear view of a structure of the present invention;

FIG. 2 is an exploded front view of a structure of the present invention;

FIG. 3 is a perspective front view of the present invention;

FIG. 4 is an exploded view of a socket in accordance with another preferred embodiment of the present invention; and

FIG. 5 is an exploded view of a socket in accordance with a further preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. The drawings are provided for reference and illustration only, but not intended for limiting the present invention.

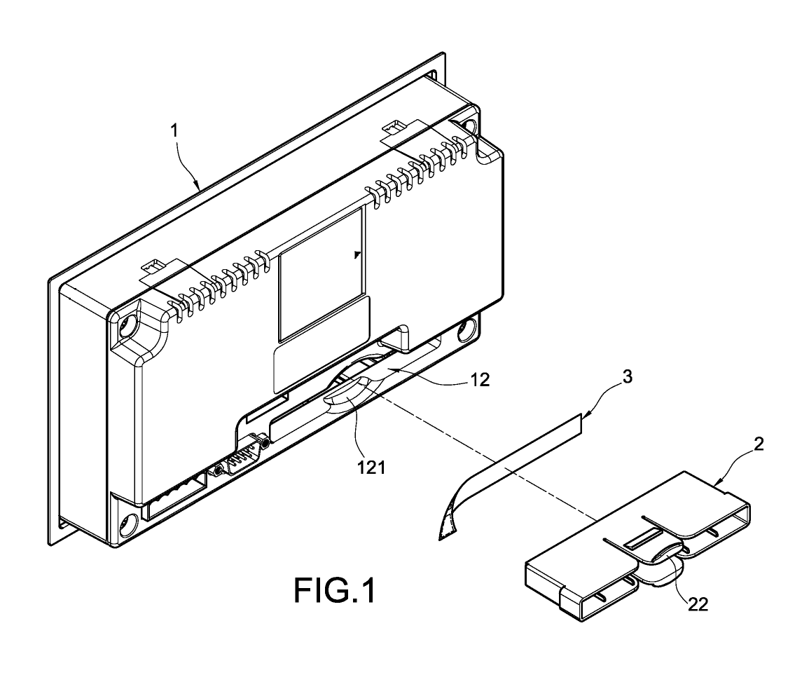

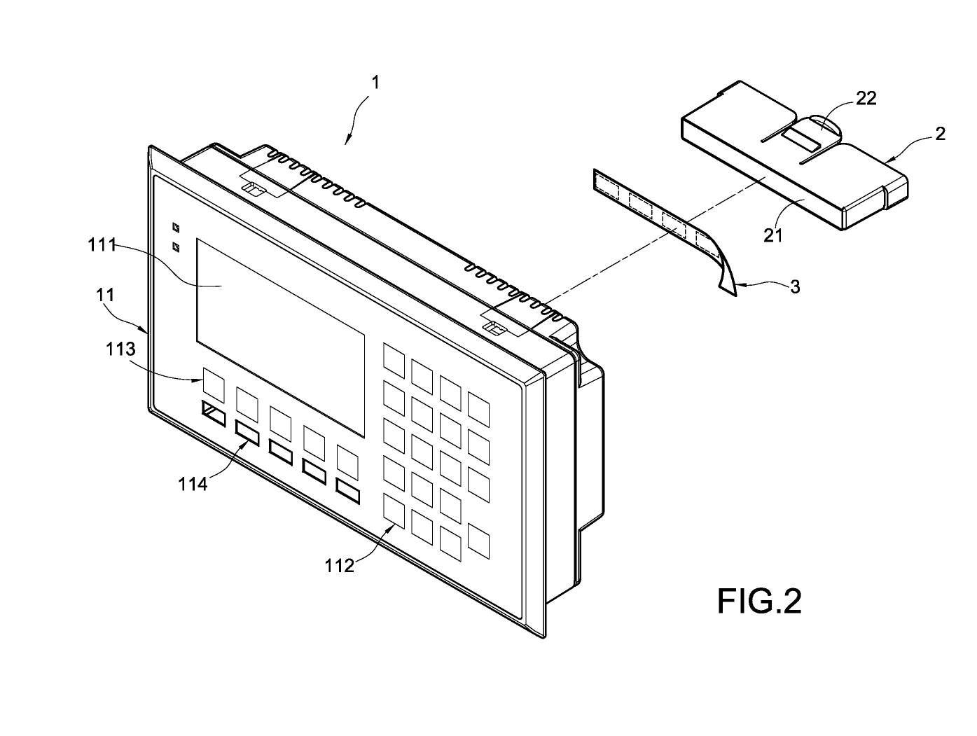

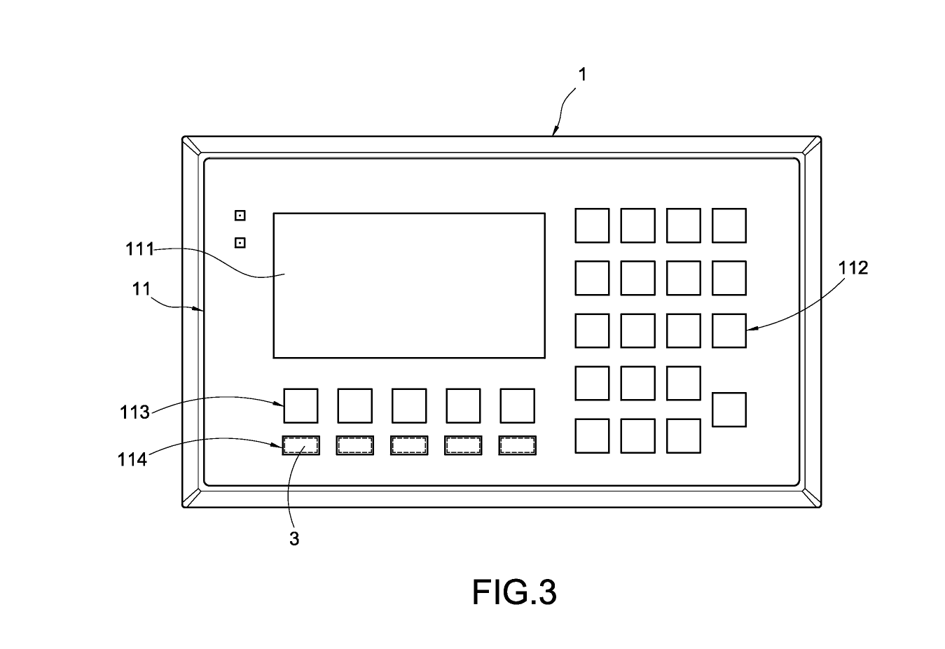

Referring to FIGS. 1 to 3 for an exploded rear view, a front view and a perspective front view of the present invention respectively, an embedded module of the present invention comprises a main man-machine system 1 and a socket 2, wherein the front end of the main man-machine system 1 has an operating interface 11, and the operating interface 11 includes a display unit 111, an input group 112, a plurality of function keys 113 and a plurality of windows 114. In FIG. 2, the plurality of function keys 113 are installed at the bottom of the display unit 111, and the plurality of windows 114 are installed below the plurality of function keys 113, and the number of windows 114 is equal to the number of function keys 113 and they are one-to-one correspondence with each other. Further, the back of the main system 1 has a rectangular insert slot 12 aligned precisely with the positions of the plurality of windows 114 and a groove 121 disposed separately on upper and lower edges at a rear end of the insert slot 12. The socket 2 is a rectangular casing contained in the insert slot 12 at the back of the main system 1 and sealed completely. The front end of the socket 2 has a rectangular casing surface 21, such that after the socket 2 is plugged into the insert slot 12, the casing surface 21 will be exposed from the plurality of windows 114 at the front end of the main system 1. Upper and lower casing surfaces disposed at upper and lower ends of the socket 2 respectively include a latching end 22, such that after the socket 2 is plugged into the insert slot 12, the latching end 22 is fixed precisely into the groove 121 of the insert slot 12 for fixing the position of the socket 2. Finally, a label 3 is attached onto the casing surface 21 at the front end of the socket 2. In this preferred embodiment, the label 3 is adhered onto the casing surface 21 by an adhering method. In the meantime, the label 3 includes a plurality of textual descriptions for reminding users about the functions, such that after the socket 2 is plugged into the insert slot 12 and each text of the label 3 are stacked in each window 114 as shown in FIG. 3, the textual description of the socket 2 attached onto the transparent window 114 allows users to know about the functions of the plurality of function keys 113 on the operating interface 11, and the label 3 can be adhered onto the casing surface 21 of the socket 2 repeatedly according to different languages.

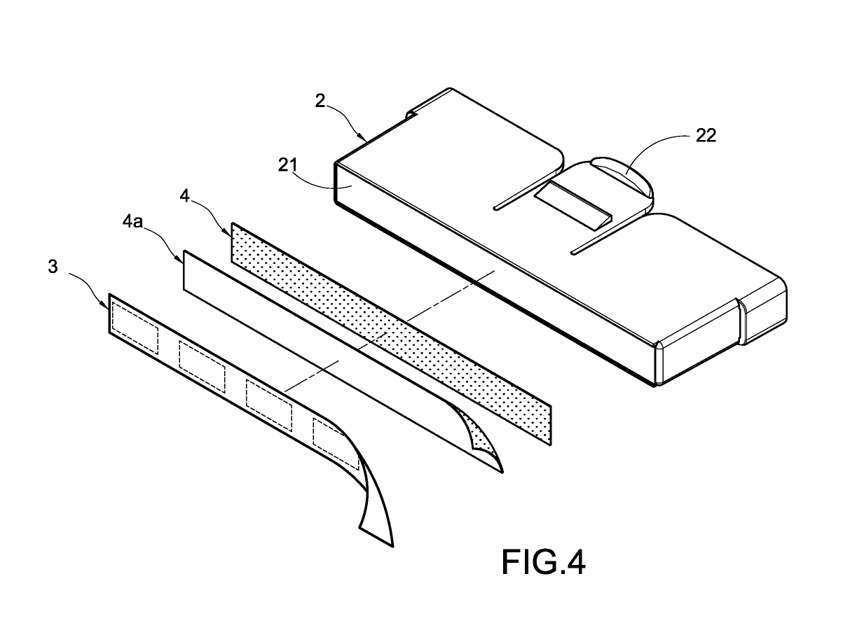

Referring to FIG. 4 for an exploded view of a socket in accordance with another preferred embodiment of the present invention, a Velcro 4 is attached onto the casing surface 21 of the socket 2, in addition to fixing the label 3 onto the casing surface 21 by an adhering method as described above, and then another Velcro 4a is attached onto the label 3, and finally two Velcros 4, 4a can be attached with each other for fixing the label 3 onto the casing surface 21 of the socket 2.

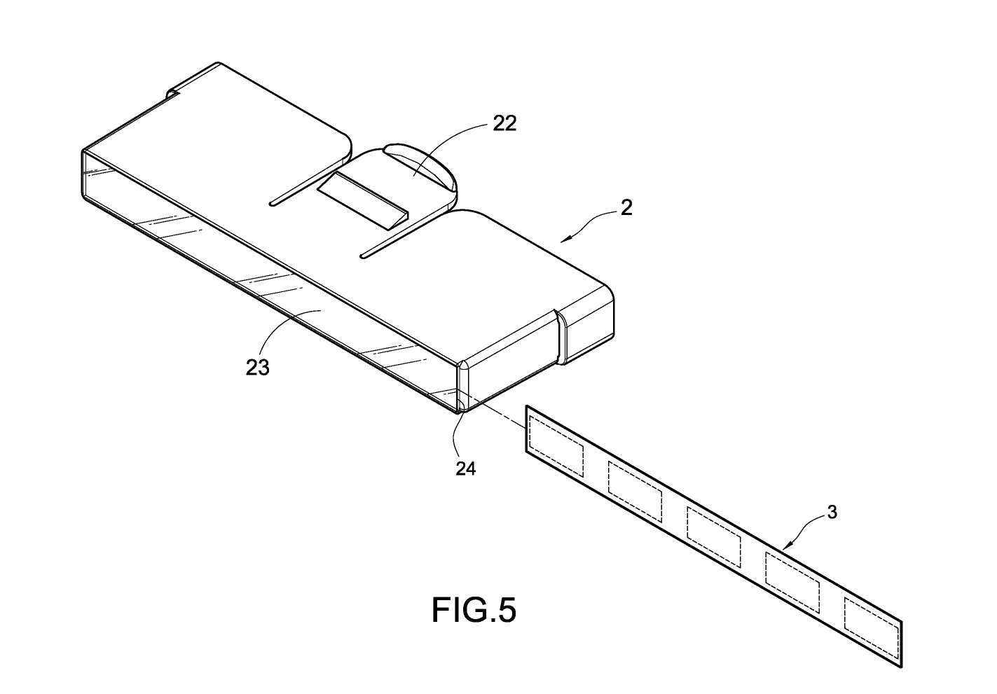

Referring to FIG. 5 for an exploded view of a socket in accordance with a further embodiment of the present invention, the casing surface 21 of the socket 2 installs a transparent plate 23 which can be a plastic plate or a glass plate and forms a gap 24 with the casing surface 21, such that a label 3 can be inserted from a lateral side of the plate 23 onto the casing surface 21. After the socket 2 is plugged into the insert slot 12, the label 3 is stacked into the window 114 at the front end of the main system 1 for describing the function of each function key 113, and the label 3 in the gap 24 can be changed repeatedly.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A man-machine interface embedded module, comprising:
a main system, having an insert slot disposed at the back of the main system, an operating interface disposed at the front of the main system and having a plurality of windows and function keys, and said each window is disposed at a position corresponding to a key; and
a socket, contained in an insert slot of the main system and having a casing surface at the front of the socket for attaching a label, such that after the socket is plugged into the insert slot, the labels on the casing surface are stacked said plurality of windows respectively;
thereby, the casing surface is stacked with each window for showing the description of the label and providing hints of the corresponding function keys.

2. The man-machine interface embedded module of claim 1, wherein the insert slot includes a groove disposed separately at upper and lower edges, and the upper and lower casing surfaces at a rear end of the socket separately have a latching end, such that after the socket is plugged into the insert slot, the latching end is latched precisely into said groove.

3. The man-machine interface embedded module of claim 1, wherein the label is fixed onto the casing surface by an adhering method.

4. The man-machine interface embedded module of claim 1, wherein the label is fixed onto the casing surface by a Velcro.

5. The man-machine interface embedded module of claim 1, wherein the casing surface of a casing has a transparent plate, and a gap is defined by the plate and the casing surface.

6. The man-machine interface embedded module of claim 5, wherein the plate is made of a transparent plastic plate.

7. The man-machine interface embedded module of claim 5, wherein the plate is made of a transparent glass plate.
